(19) United States
(12) Patent Application Publication
(10) Pub. No.: US 2006/0109827 A1
(43) Pub. Date: May 25, 2006

(54) Method for transmitting service data to wireless local area network users

(75) Inventor: Wenlin Zhang, Shenzhen (CN)

Correspondence Address: MARSHALL, GERSTEIN & BORUN LLP, 233 S. WACKER DRIVE, SUITE 6300, SEARS TOWER, CHICAGO, IL, 60606, US

(73) Assignee: Huawei Technologies Co., Ltd., Shenzhen (CN)

(21) Appl. No.: 11/261,802

(22) Filed: Oct. 28, 2005

Related U.S. Application Data
(63) Continuation of application No. PCT/CN04/00690, filed on Jun. 25, 2004.

(30) Foreign Application Priority Data
Jun. 26, 2003 (CN) 03148006.3

(51) Int. Cl. H04Q 7/24

(52) U.S. Cl. 370/338

(57) ABSTRACT

Disclosed is a method for transmitting service data to wireless local area network (WLAN) users. A service notification unit is set in the network for use in transmitting service access notices to WLAN users. After accessing the network, a WLAN user terminal immediately establishes a continuous connection between itself and the network as a common channel for transmitting service access notices. Before a service serving unit transmits service data to a WLAN user terminal that has no direct connection with the serving unit, the method further includes the service serving unit sending a service access notice to the service notification unit. The method still further includes, after receiving the service access notice, the service notification unit inquiring and acquiring the routing information of the established common channel, and sending the service access notice to the WLAN user terminal via the established common channel in accordance with the acquired routing information. Service access notices can then be sent to user terminals when the user terminals have no direct connections with the service to be accessed.

### CROSS-REFERENCES TO RELATED APPLICATIONS

This is a continuation of International Application No. PCT/CN2004/000690, which was filed on Jun. 25, 2004, and which, in turn, claimed the benefit of Chinese Patent Application No. 03148006.3, which was filed on Jun. 26, 2003, the entire disclosures of which are hereby incorporated herein by reference.

### BACKGROUND OF THE DISCLOSURE

1. Field of the Technology

The present invention relates to service access techniques, more particularly to a method for transmitting service data to Wireless Local Area Network (WLAN) users.

2. Background of the Invention

With user demand for an increasingly high rate of wireless access, there emerges the WLAN, which is able to provide high-rate wireless data access in a relatively small area. Various techniques have been used in WLANs, among which a technical standard with more applications is IEEE 802.11b. This standard utilizes the frequency band of 2.4 GHz with a data transmission rate up to 11 Mbps. Other technical standards utilizing the same frequency band include IEEE 802.11g and Bluetooth, where the data transmission rate of IEEE 802.11g is up to 54 Mbps. There are other new standards such as IEEE 802.11a and ETSI BRAN Hiperlan2, which use the frequency band of 5 GHz with transmission rates up to 54 Mbps as well.

Although there are various standards for wireless access, most WLANs are used for transferring IP data packets. The specific WLAN access standard adopted by a wireless IP network is usually transparent to the upper-level IP. Such a network is usually configured with Access Points for implementing wireless access of a user terminal and with controlling and connecting devices for implementing IP transmission.

Along with the rise and development of WLANs, the focus of research is shifting to the inter-working of WLANs with various wireless mobile communications networks, such as GSM, CDMA, WCDMA, TD-SCDMA, and CDMA2000. In accordance with the 3GPP standards, a user terminal is able to connect with Internet and Intranet as well as the home network and visited network of a 3GPP system via a WLAN access network. To be specific, when getting accessed locally, a WLAN user terminal will get connected with the 3GPP home network via a WLAN access network, as shown in FIG. 2. When roaming, it will get connected with the 3GPP visited network via a WLAN access network. Some entities of the 3GPP visited network are connected with corresponding entities of the 3GPP home network, for instance, the 3GPP Authentication, Authorization and Accounting (AAA) proxy in the visited network is connected with the 3GPP AAA Server in the home network, the WLAN Access Gateway (WAG) in the visited network is connected with the Packet Data Gateway (PDG) in the home network, as shown in FIG. 1. FIG. 1 and FIG. 2 are schematic diagrams illustrating the networking architectures of a WLAN inter-working with a 3GPP system under roaming and non-roaming circumstances, respectively.

As shown in FIG. 1 and FIG. 2, a 3GPP system primarily includes Home Subscriber Server (HSS)/Home Location Register (HLR), 3GPP AAA Server, 3GPP AAA Proxy, WAG, PDG, Offline Charging System, and Online Charging System (OCS). User terminals, WLAN access network, and all the entities of the 3GPP system together constitute a 3GPP-WLAN inter-working network, which can be regarded as a WLAN service system. In this service system, 3GPP AAA Server is in charge of the authentication, authorization, and accounting of a user, collecting the charging information sent from the WLAN access network and transferring the information to the charging system; PDG is in charge of transmission of user data from the WLAN access network to the 3GPP network or other packet data networks; and the charging system mainly receives and records users' charging information transferred from the network while OCS instructs the network to transmit online charging information periodically in accordance with the expenses of the online charged users, makes statistics and conducts control.

Under non-roaming circumstances, when a WLAN user terminal desires to get accessed directly to the Internet/Intranet, the user terminal can access to Internet/Intranet via WLAN access network after it accomplishes authentication with AAA server (AS) via WLAN access network. Should the WLAN user terminal desire to get accessed to the service of 3GPP packet switched (PS) domain as well, it may further request the service of Scenario 3 from the 3GPP home network. That is, the WLAN user terminal initiates an authorization request for the service of Scenario 3 to the AS of the 3GPP home network, which will carry out service authentication and authorization for that request; if the authentication and authorization succeed, AS will send an access accept message to the terminal and assign a corresponding PDG for the terminal. When a tunnel is established between the terminal and the assigned PDG, the terminal will be able to get accessed to the service of the 3GPP PS domain. Meanwhile, Offline Charging System and OCS record the charging information in accordance with the terminal's use of the network.

Under roaming conditions, when a WLAN user terminal desires to get accessed directly to the Internet/Intranet, it may make a request to the 3GPP home network by way of the 3GPP visited network for access to the Internet/Intranet. Should the user terminal also desire to request the service of Scenario 3 to get accessed to the service of the 3GPP PS domain, the terminal needs to initiate via the 3GPP visited network a service authorization process at the 3GPP home network. The authorization is carried out likewise between the terminal and AS of the 3GPP home network. After the authorization succeeds, AS assigns an appropriate home PDG for the terminal, then the user terminal will be able to get access to the services of 3GPP PS domain of the home network after it establishes a tunnel with the assigned PDG via the WAG in the 3GPP visited network.

It can be seen from the above process that, after a user terminal succeeds in authorization for one or one set of service and establishes a channel, the user terminal will have a corresponding IP address and can initiate accesses to the service. At this time, the user terminal can transmit data to the related serving device of the service. Meanwhile, as the IP address of the user terminal has been registered with its routing information when the terminal gets accessed, this user terminal can also receive the data sent to it by serving devices of the service and by other user terminals related with the service.

Although the user terminal has accessed the WLAN at this time, however, it may have not yet established a channel connection with the network service or have not yet established a channel to a certain service or certain set of service when there is a service needing to send data to this user terminal. This includes two situations: one is that a user terminal has accessed the WLAN but is only connected with the local services of WLAN like accessing the local Internet/Intranet; the other is that a user terminal has accessed the WLAN and activated some services based on 3GPP PS domain but has not got accessed to the service that needs to send data to it. In the case of the above situations, there is so far no solution to notifying the user terminal to establish a connection and make relevant service interaction.

### SUMMARY OF THE INVENTION

In accordance with one aspect of the disclosure, a method is useful for sending service data to a WLAN user such that a service access notice can be sent to the user terminal when a direct connection has not been established between the user terminal and the service to be accessed. The method is further useful for sending service data to a WLAN user, where a service notification unit is configured in the network for use in sending service access notices to WLAN user terminals, and the WLAN user terminal establishes a continuous connection with the network as a common channel for sending service access notices immediately after accessing the network. Before a service serving unit sends data to a WLAN user terminal that has not yet established a direct connection with the serving unit, the method further includes the service serving unit sending to the service notification unit a service access notice, and after receiving the service access notice, the service notification unit querying and acquiring the routing information of the common channel established with the WLAN user terminal. The method still further includes the service notification unit sending the service access notice to the WLAN user terminal via the established common channel in accordance with the acquired routing information.

The WLAN user terminal may establish a continuously existing IP connection with a PDG immediately after accessing the network, and the sending step includes the service notification unit, after acquiring the address of the PDG, sending the service access notice to the PDG, and the PDG sending the service access notice to the WLAN user terminal via the continuously existing IP connection. Then the sub-step of the service notification unit querying and acquiring the routing information of the common channel further includes the service notification unit, according to the identification of the WLAN user terminal, making query of the address of the PDG in the subscription information storing unit of the network to which the WLAN user terminal belongs, where the identification of the WLAN user terminal includes: network access identification (NAI), or IP address, or international mobile subscriber identification (IMSI), or mobile station ISDN (MSISDN), or public subscriber identification (PSI) of IP multimedia subsystem (IMS), or identification of session initiating protocol-universal resource locator (SIP-URL).

In some cases, the WLAN user terminal establishes a continuously existing common channel directly with the service notification unit after accessing the network, and the sending step includes the service notification unit sending the received service access notice sent from the service serving unit to the WLAN user terminal directly through the common channel established between the service notification unit itself and the WLAN user terminal.

The method may further include the WLAN user terminal removing the common channel after the WLAN user terminal logs off the network or the pre-configured time limit is expired.

The common channel may include an independently existing connection for information transmission, or a special service connection for notice serving that has been established between the WLAN user and the network, the service notification unit includes the service serving unit of short message service (SMS), the service serving unit of PUSH service, or the service serving unit of Instant Messaging; and the special notice serving service includes SMS service, PUSH service, or Instant Messaging service.

In some cases, the service access notice carries the user handling information and service data information, or carries the signaling for activating the service and the linking information of the service access. Thus the method may further include the WLAN user terminal, after receiving the service access notice, directly activating the service that has sent the service access notice based on the information carried by the notice, establishing the connection with that service, and obtaining the service data of that service via the established connection. The method may as well further include, after receiving the service access notice, the WLAN user terminal choosing either to activate that service or to reject that service in accordance with the information carried by the notice.

In accordance with another aspect of the disclosure, each WLAN user terminal, immediately after accessing the network, actively establishes a continuously existing connection with the network, for example, a connection with a PDG or with the service notification unit, and uses this connection as the common channel to send to the destination user terminal the service access notice of the service that has not established a direct connection with the destination user terminal.

In accordance with yet another aspect of the disclosure, a method is useful for sending service data to WLAN users, each WLAN user terminal actively establishing a continuous connection with the network after accessing the network. This continuous connection is an IP connection interconnecting the network devices and the user devices in a continuous time period. When a certain service needs to send data down to a WLAN user terminal but finds that no direct connection between them has been established although that user terminal has accessed the network, the service may send a service access notice, even information of service data, to the destination user terminal via the established continuous connection, notifying that user terminal to establish a connection with the service via WLAN. In this way, a solution is found to the problem that a WLAN user terminal can not learn that there is a service not connected therewith desiring to send data to the terminal.

### BRIEF DESCRIPTION OF THE DRAWINGS

FIG. 1 is a schematic diagram illustrating the network architecture of inter-working WLAN and 3GPP system under roaming circumstances.

FIG. 2 is a schematic diagram illustrating the network architecture of inter-working WLAN and 3GPP system under non-roaming circumstances.

FIG. 3 is a schematic diagram illustrating an exemplary embodiment of the structure of the 3GPP-WLAN serving network in accordance with this invention.

FIG. 4 is a flowchart depicting the implementation of service notification in accordance with one embodiment.

FIG. 5 is a flowchart depicting the implementation of service notification in accordance with another embodiment.

FIG. 6 is the flowchart depicting the implementation of service notification in accordance with yet another embodiment.

FIG. 7 is the flowchart depicting the implementation of service notification in accordance with yet another embodiment.

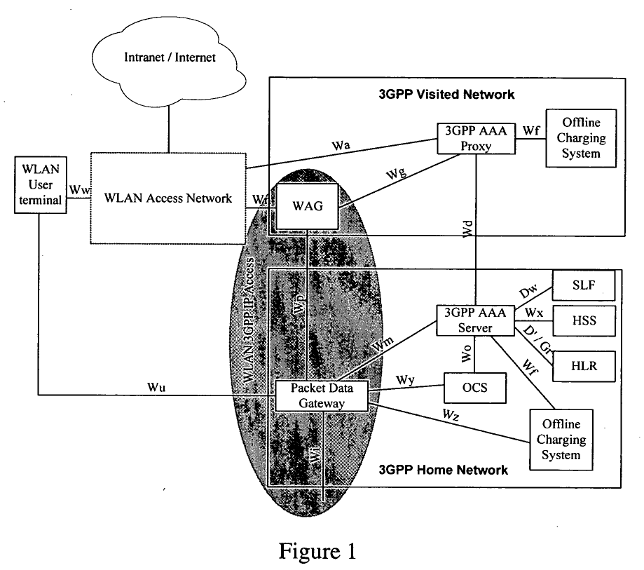

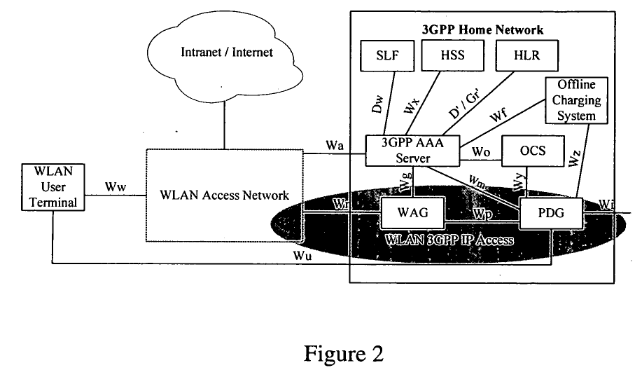

### DETAILED DESCRIPTION OF PREFERRED EMBODIMENTS

Generally speaking, disclosed herein are methods and techniques where each WLAN user terminal establishes a continuously existing connection with the network immediately after accessing the network, and uses this connection as a common channel to send to the destination user terminal the service access notice of a service having established no direct connection with the user terminal. After receiving the information of the notice, the destination user terminal can choose either to receive or not to receive the service data. If the user terminal chooses to receive the service data, it will activate that service via the WLAN and establish a connection, then obtain the service data via the established connection.

Herein, the continuously existing connection refers to a continuous connection existing after the user terminal connects with the network until the user logs off the network; or a continuous connection existing in a certain period of time according to the user's choice and not disconnected along with the end of a certain service. The establishing connection with the network may include establishing a connection between the WLAN user terminal and PDG, or a connection directly with the service notification unit. For example, the user terminal may register the IP address assigned by the network in the service notification unit and when the service notification unit sends IP data packets according to this IP address, the packets will reach the user terminal. The PDG hereinabove may be the PDG to which that WLAN user terminal belongs or a PDG designated by the network; the service notification unit may be an independently configured network entity specially for use in sending service access notices to the network entities having established direct connections with the WLAN user terminal or the service notification module in a certain service serving unit. Should the service notification unit desire to obtain the connecting route of the common channel, it will usually make query in HLR or HSS, obtain the routing information of the common channel established for the destination user terminal, and send the service access notice based on the obtained routing; or the user may register the connecting address of the WLAN user terminal in the service notification unit when log-in.

In some practical applications, it is likely that a service may find after query in the service notification unit that the destination user terminal to which the service desires to send service data has not accessed the WLAN. In this case, the service notification unit will first record the information of the service data to be sent currently and then send to the destination user terminal in two ways: one is to send actively the information of the notice or information of the service data to that destination user terminal once detecting the destination user terminal has accessed the WLAN; the other is that the destination user terminal actively makes registration in the service notification unit when accessing the WLAN such that the service notification unit will then send the information of the notice or information of the service data to the destination user terminal. Hereinafter the description in detail is directed to the situation when a WLAN user terminal has accessed the network but has established no connection with the service desiring to send data.

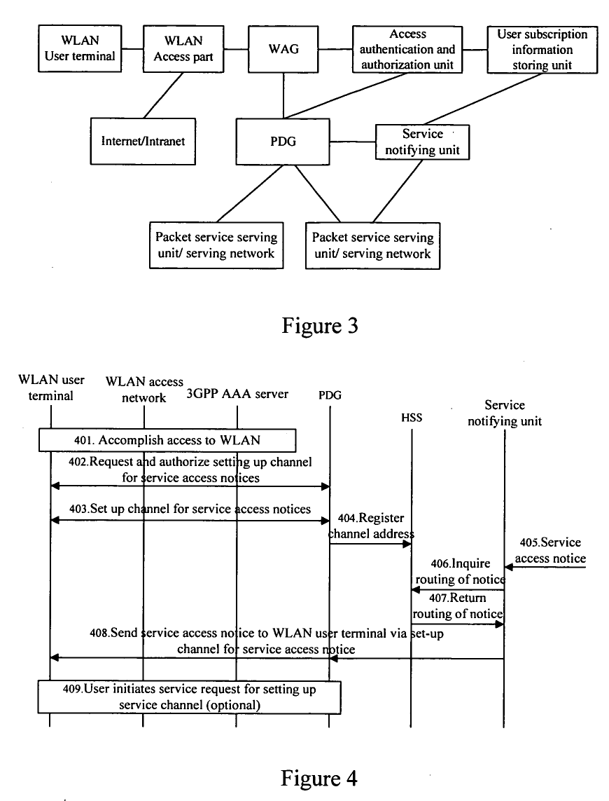

Referring now to FIG. 3, which is a schematic diagram illustrating an embodiment of the structure of the 3GPP-WLAN serving network adopted by this disclosure. In this 3GPP-WLAN serving network, the service notification unit is simultaneously connected with the user subscription information storing unit, PDG, and the packet service serving unit/serving network, where the user subscription information storing unit may be HSS or HLR, the access authentication and authorization unit may be 3GPP AS, and the service notification unit may be a certain service serving unit, for example, SMS serving unit, PUSH serving unit, or Instant Messaging service serving unit.

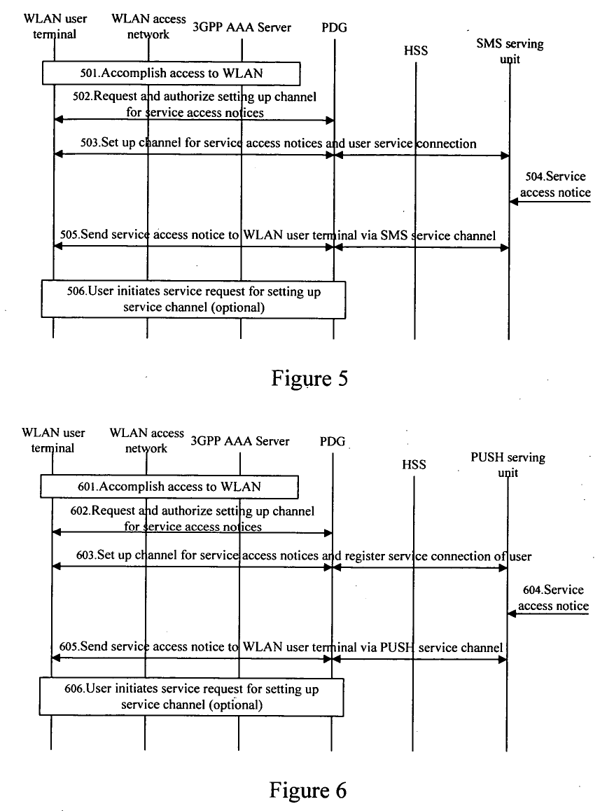

Based on the network architecture shown as FIG. 3, FIGS. 4-7 show specific embodiments implementing service notification in accordance with this disclosure, where the WLAN user terminal is the destination user terminal a service desires to access, and the service is assumed as service A in the embodiments. Embodiment 1 shown in FIG. 4 is the embodiment where the WLAN user terminal establishes a common channel with PDG while FIGS. 5-7 show the embodiments where the WLAN user terminal establishes a common channel directly with different service serving units, i.e. in these embodiments, a certain service serving unit is used as the service notification unit and the WLAN user terminal establishes a common channel directly with the service notification unit.

Embodiment 1. As shown in FIG. 4, the service access notifying process in this embodiment includes the following steps.

Steps 401 and 402: After accomplishing the WLAN access by interaction with 3GPP AS, the WLAN user terminal immediately sends to 3GPP AS a message requesting the establishment and authorization of a common channel for use in transmission of service access notices; after receiving the message, 3GPP AS will first decide whether there is a PDG designated by the network, if yes, send the address of the designated PDG to the WLAN user terminal currently sending the request, otherwise 3GPP AS will send to the WLAN user terminal the address of the PDG to which the WLAN user terminal currently sending the request belongs.

Steps 403 and 404: After obtaining the address of PDG, the WLAN user terminal establishes a common channel for transmission of service access notices with the corresponding PDG based on the address; and registers in HSS the relevant information such as the identification of the user terminal and the IP address corresponding to the common channel so that other network entities can make query. Here it is also possible for the WLAN user terminal to register at the same time directly in the service notification unit the relevant information such as the identification of the user terminal as well as the IP address corresponding to the common channel.

Step 405: When service A desires to send data to the WLAN user terminal and finds that no connection has been established with the destination user terminal when handling the transmission of the data, the serving unit of service A will first decide according to the user subscription information of that destination user terminal or according to the operating rules whether it is needed to inform the destination user terminal of the service access information, if not needed, end the transmission, otherwise the serving unit of service A will send the access notice of service A carrying the identification of the destination user terminal to the service notification unit.

Herein, the identification of the destination user terminal may be any permanent identification by which a user terminal can be identified in the mobile communications network, such as NAI, IP address, IMSI, MSISDN, PSI of IMS, or SIP-URL identification; the user subscription information means that it is the user that will decide which services must be sent to the user terminal, which services are to be sent to the user terminal depending on the current demand or the current operating environment; the operating rules refer to the principles determined by the operator as which services are to be sent to the user terminal under which circumstances. The serving unit of service A finding no connection with the destination user terminal refers to that the serving unit of service A finds the destination user terminal has not made authorization registration in the serving unit and no relevant information has been stored in the unit, for instance, no IP address is stored or the IP address is invalid data, so the service serving unit does not believe that the user terminal can be reached.

If the WLAN user terminal has registered the relevant information in the service notification unit after the common channel is established but the type of the user identification sent by the service serving unit is not consistent with the user identification type saved in the service notification unit, the service notification unit will make further query in the user subscription information storing unit of the corresponding user identification of the type consistent with the self-stored type, and then decide according to the user identification found whether the WLAN user terminal has established a common channel with the notification unit.

Steps 406 and 407: After receiving the access notice of service A, the service notification unit sends to HSS a route-query request which carries the identification of the destination user terminal, and makes query of the information of the connecting route of the destination user terminal based on the identification of the destination user terminal. After receiving the request, HSS will first check whether the user terminal has accessed the network, and if yes, return the address of the PDG which has established a common channel with the user terminal to the service notification unit.

If the WLAN user terminal has registered the relevant information of the common channel in the service notification unit, Steps 406 and 407 may be skipped.

Step 408: The service notification unit sends the service access notice of service A to the PDG according to the obtained address thereof, and then the PDG sends the access notice of service A to the destination user terminal via the established common channel.

In the implementing process of the above steps, the service access notice may include information to be handled by a user, for example, user information able to be displayed for a user to make decision and choice, or instruction to activate a service or linking information of a service for a user terminal to complete automatically the processes like activating the service and establishing connection with the service serving unit. The notice may as well include the service data to be sent by the current service to be accessed, i.e. send the service data directly to the destination user terminal via the service access notice.

Step 409 may be further included after step 408. After receiving the access notice of service A, the user terminal may automatically activate service A based on the information contained in the notice, then establish the service connection with the serving unit of service A after the service authentication and authorization by the network and obtain the corresponding data from the serving unit of service A. Here, the destination user terminal completes the operation of activating the service, establishing the connection and obtaining the data according to the instruction of service activation or the linking information in the service access notice. The destination user terminal may also decide to activate or reject service A according to the choice of the destination user, where the destination user makes the choice based on the displayed information in the service access notice.

Embodiment 2. As shown in FIG. 5, in this embodiment an SMS serving unit is taken as the service notification unit, and the service access notifying process in this embodiment includes the following steps.

Steps 501 and 502 are basically the same as the steps 401 and 402 in Embodiment 1, except that it is to 3GPP AS that the WLAN user terminal makes a request for establishing an SMS service channel. After receiving the request, 3GPP AS returns the address of the service serving unit to the WLAN user terminal. The service serving unit in this embodiment is an SMS serving unit.

Step 503: After receiving the IP address of the SMS serving unit, the WLAN user terminal establishes a common channel for use in transmission of service access notices directly with the SMS serving unit via the PDG to which the user terminal belongs. After establishing the common channel, the WLAN user terminal will register the relevant information, such as the identification of the user terminal and the IP address corresponding to the common channel in the SMS serving unit.

Step 504: When service A want to send data to this WLAN user terminal, and finds that no connection has been established between itself and the destination user terminal when handling the transmission of the data, the serving unit of service A will first decide according to the user subscription information of that destination user terminal or according to the operating rules whether it is needed to inform the destination user terminal of the service access information, if not needed, end the transmission, otherwise the serving unit of service A will send the access notice of service A to the SMS serving unit. The access notice may carry the user information to be displayed for the user to make decision and choice; or carry the instruction for service activation or the linking information of service for the user terminal to complete automatically the processes such as activating the service and establishing a connection with the service serving unit. The notice may as well carry the service data of service A to be sent.

Step 505: After receiving the access notice of service A, the SMS serving unit directly sends the access notice of service A and even the information of the service data to the WLAN user terminal via the common channel established therewith.

Likewise, step 506 may further include after step 505: after receiving the service access notice, the WLAN user terminal may automatically activate service A, or choose to activate service A or reject it. The specific implementing process is the same as step 409.

Embodiment 3. As shown in FIG. 6, in this embodiment a PUSH serving unit is taken as the service notification unit, and the service access notifying process in this embodiment includes the following steps.

Steps 601 and 602 are basically the same as the steps 401 and 402 in Embodiment 1, except that it is the address of the service serving unit that 3GPP AS returns to the WLAN user terminal after receiving the request for establishing the connection. The service serving unit in this embodiment is a PUSH serving unit.

Steps 603-605: basically the same as the steps 503-505 in Embodiment 2, except that the SMS serving unit in these steps is replaced by the PUSH serving unit.

Likewise, step 606 may further include after step 605: after receiving the service access notice, the WLAN user terminal may automatically activate service A, or choose to activate service A or reject it. The specific implementing process is the same as step 409.

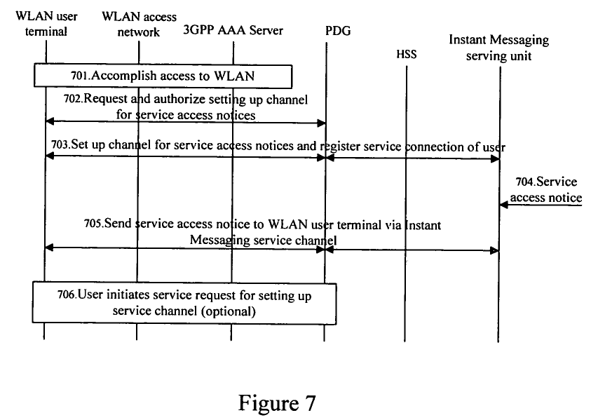

Embodiment 4. As shown in FIG. 7, in this embodiment an Instant Messaging serving unit is taken as the service notification unit, and the service access notifying process in this embodiment includes the following steps.

Steps 701 and 702 are basically the same as the steps 401 and 402 in Embodiment 1, except that it is the address of the service serving unit that 3GPP AS returns to the WLAN user terminal after receiving the request for establishing the connection. The service serving unit in this embodiment is an Instant Messaging serving unit.

Steps 703-705 are basically the same as the steps 503-505 in Embodiment 2, except that the SMS serving unit in the steps is replaced by the Instant Messaging serving unit.

Likewise, step 706 may further include after step 705: after receiving the service access notice, the WLAN user terminal may automatically activate service A, or choose to activate service A or reject it. The specific implementing process is the same as step 409.

In Embodiments 2 through 4, if the type of the user identification sent to the current serving unit by the service serving unit to be accessed is not consistent with the user identification type saved in the current serving unit, then the current serving unit will also have to make further query in the user subscription information storing unit for the corresponding user identification of the type consistent with the self-stored type, and then decide, based on the user identification found, whether the WLAN user terminal has established a common channel with the current serving unit.

The foregoing description sets forth preferred embodiments of the disclosed method and should not be construed as limiting the scope of protection scope thereto.

1. A method for transmitting service data to wireless local area network (WLAN) users, comprising the steps of:
setting a service notification unit in a network used for sending service access notices to WLAN user terminals, and wherein a WLAN user terminal, after accessing the network, establishes a continuous connection between the WLAN user terminal and the network as a common channel for sending the service access notices, the method further comprising the following steps before a service serving unit transmits data to the WLAN user terminal that has not yet established a direct connection with the service serving unit:
(A) said service serving unit sending to said service notification unit a service access notice, after receiving the service access notice, said service notification unit querying and acquiring the routing information of said established common channel; and
(B) the service notification unit sending the service access notice to said WLAN user terminal via the established common channel in accordance with the routing information acquired in step (A).

2. A method according to claim 1, wherein the WLAN user terminal establishes a continuously existing IP connection between the WLAN user terminal and a Packet Data Gateway (PDG) after accessing the network, and wherein step (B) further comprises the steps of:
the service notification unit acquiring an address of the PDG with which said continuously existing IP connection has been established;
sending the service access notice to the PDG according to the acquired address; and
the PDG sending the service access notice to the WLAN user terminal via said continuously existing IP connection.

3. A method according to claim 1, wherein the WLAN user terminal establishes a continuously existing common channel directly between the WLAN user terminal and the service notification unit after accessing the network, and wherein step (B) comprises the service notification unit sending the received service access notice sent by the service serving unit to the WLAN user terminal directly through the continuously existing common channel.

4. A method according to claim 2, wherein step (A) further comprises the service notification unit, according to the identification of the WLAN user terminal, querying the address of said PDG to the subscription information storing unit of the network to which the WLAN user terminal belongs.

5. A method according to claim 4, wherein said identification of the WLAN user terminal comprises a Network Access Identification (NAI), or an IP address, or an International Mobile Subscriber Identification (IMSI), or a Mobile Station International ISDN (MSISDN) number, or a Public Subscriber Identification (PSI) of IP Multimedia Subsystem (IMS), or an identification of Session Initiating Protocol-Universal Resource Locator (SIP-URL).

6. A method according to claim 1, further comprising the WLAN user terminal releasing said common channel after the WLAN user terminal logs off the network or the pre-configured time limit is expired.

7. A method according to claim 1, wherein said common channel is an independently existing connection for information transmission, or a connection for special notice serving service that has been established between the WLAN user terminal and the network.

8. A method according to claim 7, wherein said service notification unit is a service serving unit of a short message service (SMS), or a serving unit of a PUSH service, or a service serving unit of Instant Messaging; said special notice serving service is an SMS service, or a PUSH service, or an Instant Messaging service.

9. A method according to claim 1, wherein said service access notice carries the user handling information and service data information, or carries the signaling for activating the service and the linking information of the service access.

10. A method according to claim 9, further comprising the WLAN user terminal, after receiving the service access notice, directly activating the service that has sent the service access notice based on the information carried by the notice, establishing a connection between itself and the service, and obtaining the service data of that service via the established connection.

11. A method according to claim 9, further comprising the WLAN user terminal, after receiving the service access notice, choosing either to activate that service or to reject that service in accordance with the information carried by the notice.
